(19) United States
(12) Patent Application Publication
(10) Pub. No.: US 2025/0287258 A1
(43) Pub. Date: Sep. 11, 2025

(54) MULTI-ACCESS POINT COORDINATED SERVICE PERIODS

(71) Applicant: Cisco Technology, Inc., San Jose, CA (US)

(72) Inventors: Brian D. Hart, Sunnyvale, CA (US); Malcolm M. Smith, Richardson, TX (US); Binita Gupta, San Deigo, CA (US)

(73) Assignee: Cisco Technology, Inc., San Jose, CA (US)

(21) Appl. No.: 19/073,934

(22) Filed: Mar. 7, 2025

Related U.S. Application Data
(60) Provisional application No. 63/562,670, filed on Mar. 7, 2024.
(60) Provisional application No. 63/645,595, filed on May 10, 2024.

(51) Int. Cl. H04W 28/02

(52) U.S. Cl. CPC H04W 28/0268

(57) ABSTRACT

Multi-Access Point (AP) coordinated Service Periods (SPs) may be provided. Flow-set data is determined comprising data for one or more Quality of Service (QoS) flows-sets of one or more clients. The flow-set data is sent to one or more neighboring co-channel APs. Neighbor flow-set data is received comprising data for one or more neighbor QoS flow-sets from at least one of the one or more neighboring co-channel APs. Service Level Agreements (SLAs) are established for the one or more QoS flow-sets and the one or more neighbor QoS flow-sets based on the flow-set data and the neighbor flow-set data. One or more SPs are scheduled for at least one of the one or more QoS flow-sets and the one or more neighbor QoS flow-sets based on the SLAs.

### RELATED APPLICATION

Under provisions of 35 U.S.C. § 119(e), Applicant claims the benefit of and priority to U.S. Provisional Application No. 63/562,670, filed Mar. 7, 2024, and U.S. Provisional Application No. 63/645,595, filed May 10, 2024, the disclosures of which are incorporated herein by reference in their entirety.

### TECHNICAL FIELD

The present disclosure relates generally to providing multi-Access Point (AP) coordinated Service Periods (SPs).

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for Multi-Access Point (AP) coordinated Service Periods (SPs) in accordance with aspects of the present disclosure.

FIG. 2 is a block diagram of communication links for disseminating flows in accordance with aspects of the present disclosure.

FIG. 3 is a block diagram of a SP schedule in accordance with aspects of the present disclosure.

FIG. 4 is a block diagram of a SP schedule with pause and resume operations in accordance with aspects of the present disclosure.

FIG. 5 is a block diagram of a SP schedule with queue jumping in accordance with aspects of the present disclosure.

FIG. 6 is a block diagram of a SP schedule with SP chaining in accordance with aspects of the present disclosure.

FIG. 7 is a block diagram of a SP schedule with refarming in accordance with aspects of the present disclosure.

FIG. 8 is a flow chart of a method for Multi-AP coordinated SPs in accordance with aspects of the present disclosure.

FIG. 9 is a block diagram of a computing device in accordance with aspects of the present disclosure.

FIG. 10 is a block diagram of a computing device in accordance with aspects of the present disclosure.

### DETAILED DESCRIPTION

### Overview

Multi-Access Point (AP) coordinated Service Periods (SPs) may be provided. Flow-set data is determined comprising data for one or more Quality of Service (QOS) flows-sets of one or more clients. The flow-set data is sent to one or more neighboring co-channel APs. Neighbor flow-set data is received comprising data for one or more neighbor QoS flow-sets from at least one of the one or more neighboring co-channel APs. Service Level Agreements (SLAs) are established for the one or more QoS flow-sets and the one or more neighbor QoS flow-sets based on the flow-set data and the neighbor flow-set data. One or more SPs are scheduled for at least one of the one or more QoS flow-sets and the one or more neighbor QoS flow-sets based on the SLAs.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Intra-Basic Service Set (BSS) determinism is the ability of Access Points (APs) and/or other network devices to provide predictable and reliable network behavior within the BSS. In wireless networking, signals network devices transmit can propagate away from and beyond the intended recipient and cause interference for other communication links. This interference can impact the ability of APs and/or network devices to provide predictable and reliable network behavior, including increasing latency, packet loss, requiring retransmissions, reducing throughput, dropping connections, causing jitter, causing poor signal quality, and so on.

Various techniques are provided for mitigation of the interference at the Media Access Control (MAC) layer and Physical (PHY) layer. For example, the Institute of Electrical and Electronics Engineers (IEEE) 802.11 protocol describes using Carrier-Sense Multiple Access with Collision Avoidance (CSMA/CA) as an interference mitigation technique, but extension towards greater determinism are sought or otherwise needed for applications including augmented reality, virtual reality, and mixed reality. Within a BSS, triggered access and/or Restricted-Target Wake Time (R-TWT) can provide a high degree of intra-BSS determinism. There is no coordination between co-channel BSSs, however, which weakens any guarantees sought by implementing triggered access and/or R-TWT. Thus, coordinated interference mitigation techniques are necessary for certain applications (e.g., for supporting Time Sensitive Networking (TSN)) and can be useful for all applications.

Multi-AP Coordination (MAPC) techniques can be implemented to mitigate interference, such as using Coordinated-Time Division Multiple Access (C-TDMA), Coordinated-R-TWT (C-RTWT), AP Query Report Protocol (AQRP), Coordinated-Spatial Reuse (C-SR), Coordinated-Beam Forming (C-BF), Coordinated-Orthogonal Frequency Division Multiple Access (C-OFDMA), Joint Transmission (JT), Joint Reception (JR), and/or the like. However, the various techniques have different advantages and disadvantages. For example, AQRP may be a more effective technique than C-TDMA, but the gains of AQRP dimmish as the number of co-channel neighboring BSSs increases. AQRP may be inefficient beyond three or four co-channel neighboring BSSs. Additionally, C-TDMA and C-RTWT may not be suitable for multi-service networks.

MAPC can be implemented as described herein to provide coordinated interference mitigation techniques for lowering latency, avoiding collisions, and/or otherwise improving network performance and determinism. The MAPC implementation can include APs disseminating traffic flows, sequencing Service Periods (SPs) by priority, enabling queue jumping, protecting SPs via chaining, refarming between SPs, and/or the like. In certain embodiments, the MAPC techniques described herein can leverage the beneficial or otherwise desired features of C-RTWT, Periodic Traffic Scheduler Inputs (PTSIs), C-TDMA, and/or other MAPC techniques. SPs may be a portion of a Transmit Opportunity (TXOP), and SPs in a same TXOP can be connected via SP chaining. The TXOPs of multiple APs can be connected by the TXOPs by a short space (e.g., Short Interframe Space (SIFS), Point Coordination Function Interframe Space (PIFS), etc.) and/or backoff. SPs can then be connected through multiple TXOPs via SP chaining.

The MAPC techniques can support overlapping networks from different administrative domains, even when neighboring networks are operating on the same channel. Further, the MAPC techniques can enable a multi-service network that simultaneously supports ultra-reliable, ultra-low latency channel access capable of supporting TSN, augmented reality, virtual reality, mixed reality, automated manufacturing, Quality of Service (QoS) and/or other scheduled traffic, devices subject to Irregular In-Device Coexistence (IDC) challenges, devices with peer-to-peer traffic, client power savings, legacy APs and clients and/or the like. Compliance with global regulations is also followed when implementing the MAPC techniques. The described MAPC techniques therefore provide system efficiency, implementation simplicity, and acceptable fairness with legacy generations.

The MAPC techniques may be described herein as initiated, established, and performed between APs and Stations (STAs), but the MAPC techniques can be initiated and/or established by a primary AP, a controller, and/or another network device in additional embodiments. For example, controllers, central systems, and/or the like for the APs of different entities may communicate to establish the parameters of the MAPC techniques for the APs. The controllers, central systems, and/or other devices associated with the APs may establish the parameters or otherwise initiate the MAPC techniques when the APs of different entities cannot directly communicate.

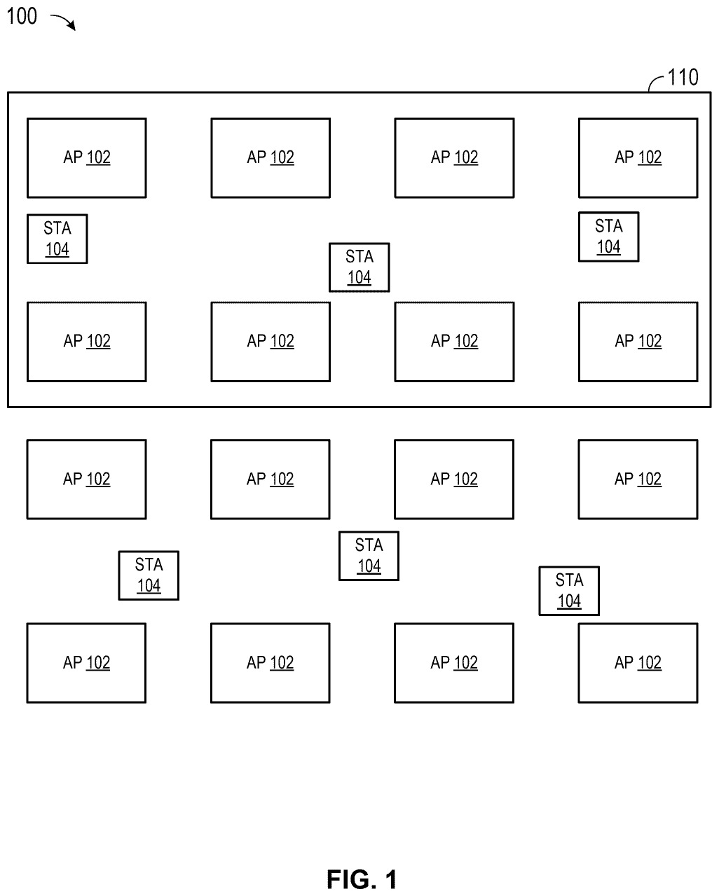

FIG. 1 is a block diagram of an operating environment 100 for Multi-AP coordinated SPs. The operating environment 100 includes APs 102 and STAs 104, such as client devices and other non-AP devices. The APs 102 can enable devices to access a network by creating one or more Wireless Local Area Networks (WLANs). The STAs 104 can be any device that connects to a wireless network (e.g., via the APs 102), including a smart phone, a tablet, a personal computer, a server, an Internet-of-Things device, and the like. Once a STA 104 associates with an AP 102, the STA 104 can exchange data with other systems on a network via the AP 102. There may be a different number of devices in the operating environment 100 in further embodiments, including APs 102, STAs 104, controllers, and/or the like.

A portion of the APs 102 can be part of an entity group 110, a group installed, managed, and/or otherwise controlled by an entity. The entity can arrange the APs 102 in the entity group 110 so APs 102 on the same channel are spaced out to reduce interference. For example, the APs 102 in the entity group 110 can be arranged so no APs 102 operating on a same channel are positioned next to each other. However, the APs not part of the entity group 110 are not installed, managed, and/or otherwise controlled by the entity, so the entity cannot prevent APs 102 in the entity group 110 from operating directly next to an AP 102 operating on the same channel and not part of the entity group 110. Thus, the operating environment 100 may include overlapping networks and/or neighboring co-channel APs 102 that can cause interference absent coordination.

Neighboring co-channel APs 102 and/or the associated STAs 104 can perform MAPC techniques to provide coordinated interference mitigation techniques for lowering latency, avoiding collisions, and/or otherwise improving network performance and determinism. The techniques comprise disseminating flows, establishing Service Level Agreements (SLAs) for flow-sets, sequencing SPs by priority, enabling queue jumping, protecting SPs via SP chaining and TXOP chaining, and refarming gaps between chained SPs. The SPs include one or more TXOPs and have an actual start time that is the same or later than a start time of its Target SP Transmission Time (TSTT), a time interval for the SP to occur. For example, the SP can occur at the start time of the TSTT when the medium is available and can occur at the start time or after of the TSTT when the medium is busy and the SP is contended to occur (e.g., according to priority). The SPs can be paused, such as for higher priority SPs, and resumed later. Further, the SPs have a distinct, non-time-bounded end understood by the devices.

The APs 102 and/or STAs 104 can perform the MAPC techniques to support devices with IDC challenges by (i) not requiring rigidly regular Target Wake Time (TWT) and R-TWT SPs and (ii) when a client (e.g., an STA 104) is not available for a given SP, truncating the SP and attempting the communication later (e.g., during the maximum-possible CSMA/CA time the devices can take to sense the channel, perform backoff, and successfully transmit data while avoiding collisions). The APs 102 and/or STAs 104 can (i) include non-QoS traffic (e.g., via OFDMA) for efficiency when QoS traffic in an SP is short or otherwise does not use a significant portion of the SP and (ii) reserve SPs only for the known, periodic QoS traffic and leave every other communication for CSMA/CA so legacy STAs are supported. STAs 104 capable of using ultra-high reliability techniques (e.g., Wi-Fi 8 as described in IEEE 802.11bn) can use ultra-reliable, ultra-low latency channel access for any QoS traffic and use ubiquitous Uplink OFDMA Random Access (UORA) for aperiodic traffic. Additionally, APs 102 may estimate when to expect QoS traffic to and/or from STAs 104 (e.g., based on the traffic being periodic, the data type, etc.) to schedule SPs for communicating STAs.

In certain embodiments, the APs 102 and/or other network devices can monitor whether devices participating in the MAPC techniques are operating as expected. For example, devices can be monitored to determine whether they are scheduling SPs correctly (e.g., according to priority), operating according to associated SLAs, performing queue jumping correctly, protecting SPs via SP chaining, refarming gaps, and/or the like. If a device is not operating as expected the APs 102 and/or other network devices can exclude the device from participating in the MAPC techniques. The monitoring may be necessary when the APs 102 are in different administrative domains or otherwise associated with different entities. In some embodiments, an AP 102 can request an AP 102 identified as not operating correctly to fix the operation. This allows APs 102 to adjust operation before being excluded.

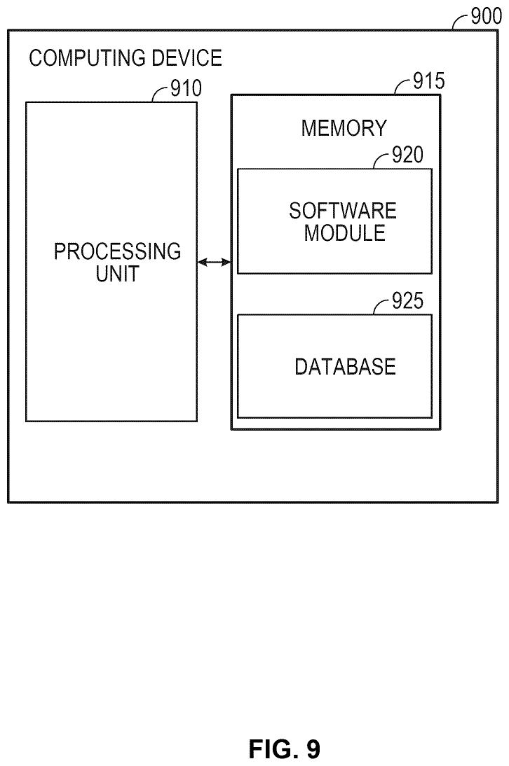

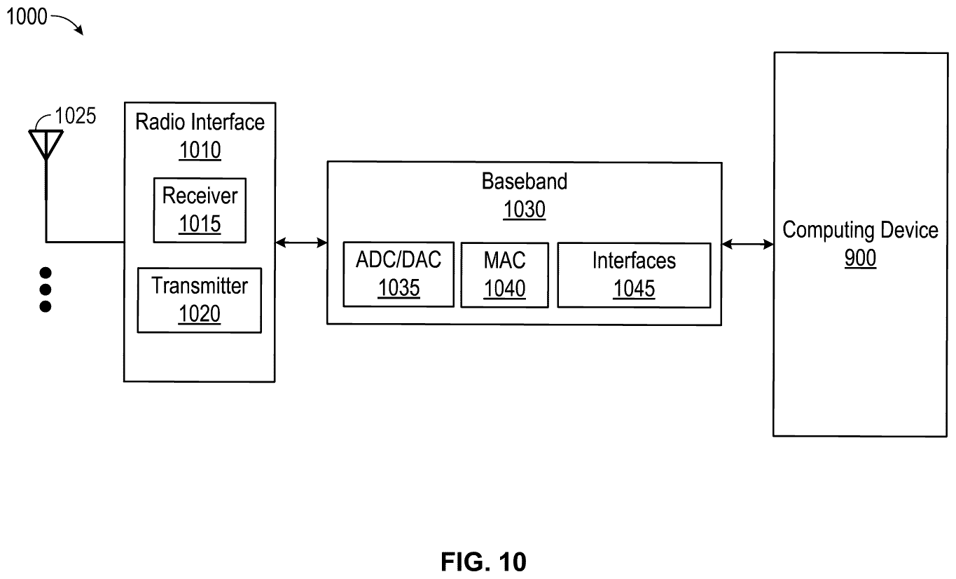

The elements described above of the operating environment 100 (e.g., the APs 102, the STAs 104, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 9 and 10, the elements of the operating environment 100 may be practiced in a computing device 900 and/or communications device 1000.

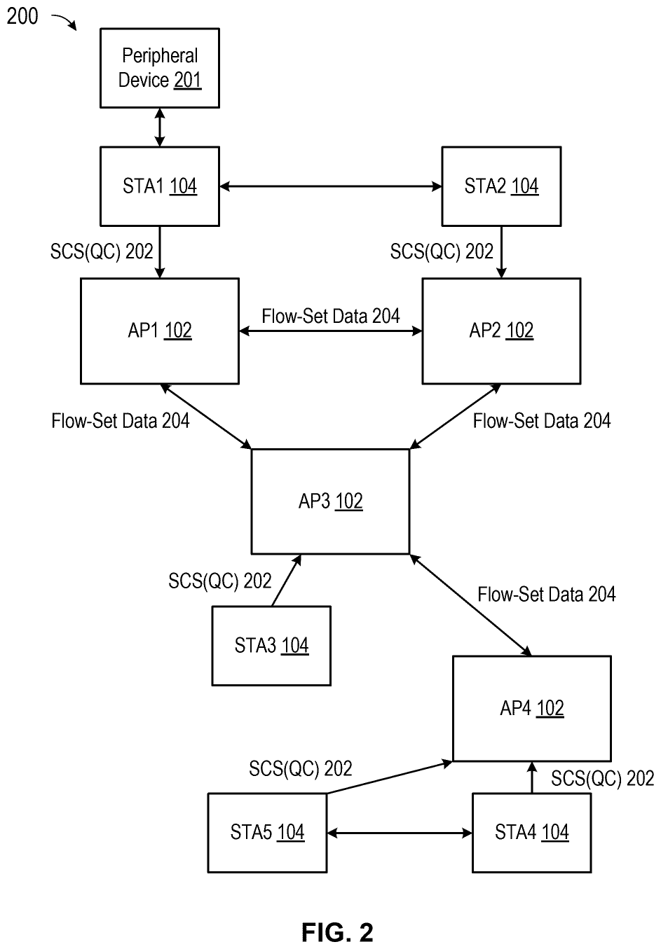

FIG. 2 is a block diagram of communication links 200 for disseminating flows. The communication links 200 include links between APs 102, links between STAs 104, and links between APs 102 and STAs 104. For example, the communication links 200 include a link between (i) STA1 104 and a peripheral device 201, (ii) STA1 104 and STA2 104, (iii) STA1 104 and AP1 102, (iv) STA2 104 and AP2 102, (v) AP1 102 and AP2 102, (vi) AP1 102 and AP3 102, (vii) AP2 102 and AP3 102, (viii) STA3 104 and AP3 102, (ix) AP3 102 and AP4 102, (x) STA4 104 and STA5 104, (xi) STA4 104 and AP4 102, and (xii) STA5 104 and AP4 102. The peripheral device 201 can be any device that connects with a STA 104 and can have associated QoS traffic flows via STA1 104. There may be a different amount of devices and/or communication links in further embodiments. As described above, the links between APs 102 may be communications between controllers, systems, and/or other network devices associated with the respective AP 102 in certain embodiments, for example because some neighboring co-channel APs 102 may not be able to directly communicate.

The STAs 104 report their periodic QoS traffic flows (e.g., the communications of data packets between a source and destination with a particular QoS requirement) to the associated AP 102. In certain embodiments, the STAs 104 report the periodic QoS traffic flows via a Stream Classification Service (SCS) frame 202 comprising a QoS Characteristics (QC) element (e.g., a SCS (QC) frame). The QC element includes information for determining the requirements and parameters associated with the respective QoS traffic flow, such as traffic type, traffic class, priority level, the minimum data rate, the maximum data rate, bandwidth requirement, jitter requirements, maximum acceptable latency, acceptable packet loss percentage, maximum burst size, scheduling and admission control parameters, and/or the like. The STAs 104 can also report communications links such as to peripheral devices 201 and other STAs 104. For example, STA1 104 can report the communication link to the peripheral device 201 and STA2 104 to AP1 102.

The APs 102 can treat periodic beacons and Delivery Traffic Indication Message (DTIM) groupcast flows as additional flows. The APs 102 will typically treat beacon and groupcast traffic flows as having higher priority than the QoS traffic flows. The APs 102 can perform Deep Packet Inspection (DPI), traffic analysis, and/or the like to further identify additional flows of the STAs 104. Thus, the APs 102 can identify QoS traffic flows and additional flows of the APs 102 and/or the STAs 104 for implementing the MAPC techniques.

Once the APs 102 receive the QoS traffic flows reports from the STAs 104 and/or otherwise determine the flows of the STAs 104, the APs 102 can aggregate like flows into flow-sets. For example, an AP 102 can determine one or more flows are like flows for inclusion in a flow set if the one or more flows have the same or similar Service Interval (SI) and the same or similar values for the relative position of the Service Start Time (SST) within a SI (e.g., mod(SST, SI)) so flows in a flow-set will start around the same time and not cause a delay. When the SST is not specified by the STA 104, an AP 102 can use adjust the value to form larger flow-sets with the same or similar SSTs.

In certain embodiments, the APs 102 create PTSIs for the flow-sets. The PTSIs can include SST, SI, delay bounds, Media Access Control (MAC) Service Data Unit (MSDU) delivery ratio, priority, minimum SP duration, nominal SP duration, minimum data rate, for SPs associated with the flow-set, and/or the like. Thus, the PTSIs can be used when establishing SLAs between APs 102 and scheduling SPs. Due to Multi-Link Operation (MLO), Variable Bit Rate (VBR), retries, rate adaptation, deferral for legacy Wi-Fi and non-Wi-Fi interference, and so on, the APs 102 may have no expectation that SPs have a particular duration.

After the flow-sets are determined, the APs 102 can disseminate between neighboring (e.g., one-hop) co-channel APs flow-set data 204 detailing the flow-sets (e.g., the flows in each set, the QC information and/or other information of the flows, the PTSIs, etc.). Thus, AP1 102 can send flow-set data 204 to AP2 102 and AP3 102 but not AP4 102 since AP4 102 is not a neighboring AP or is otherwise out of range for example. The APs 102 can send the flow-set data 204 in-band (e.g., via a management frame, an AP-to-AP SCS (QC) frame, elements in a beacon, etc.) or out-of-band (e.g. over Ethernet).

Using the exchanged flow-set data 204, the neighboring co-channel APs 102 determine SLAs for every flow-set to meet the requirements and parameters of the respective flow-set. For example, the SLAs can include the frequency of SPs for a flow set (e.g., every twenty milliseconds), a requirement to receive data within fifteen milliseconds with ninety-nine percent reliability, and so on.

Given the flow-set data 204 and the SLAs for each flow-set, the APs 102 can independently understand and agree on the sequencing of SPs, therefore determining which SP should be scheduled next. For each flow-set's next SP, a TSTT is determined. For beacons and DTIM traffic, the TSTT is the Target Beacon Transmission Time (TBTT). The TSTT for a QoS flow-set SP can be determined as the SST plus the number of SIs in the SP (e.g., SST+n*SI). In embodiments, a Priority Time (PT), indicating a maximum delay after the start of the TSTT for a SP to occur, is determined for each flow-set's next SP. For beacons and DTIM traffic, the PT is defined by the TBTT. For QoS flow-sets, the PT can be determined as the maximum value of a delay bound and a Delay Bound Traffic Identifier (DBTID) (e.g., SST+n*SI+max (delay bound, DBTID)). The delay bound may be a period determined for the associated flow-set, such set by or as based on the QC information and/or other information of the flows, the PTSIs, and so on. The DBTID may be a per-TID lower bound on the delay bound.

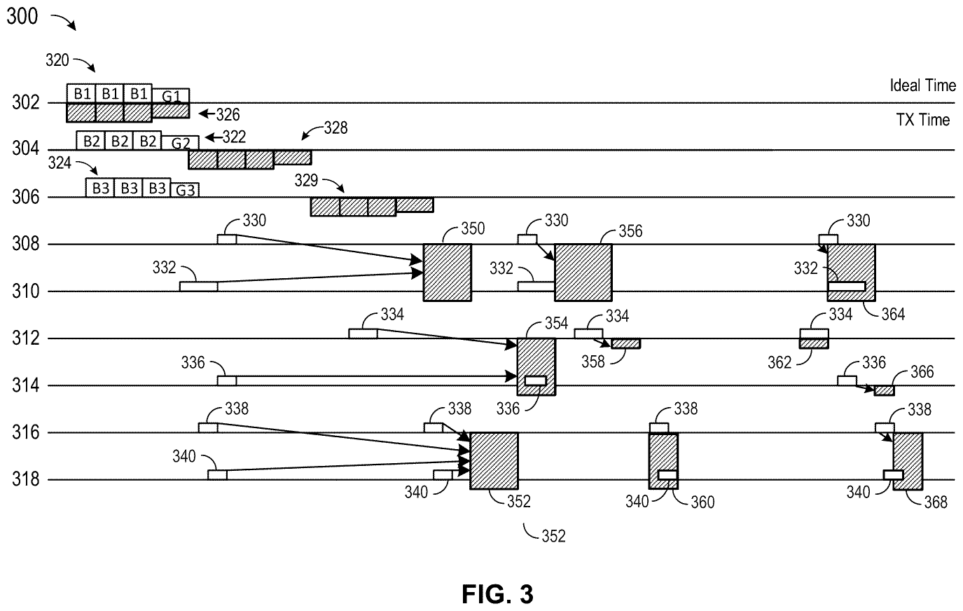

The APs 102 can determine the sequence of the SPs first based on the priority of the traffic (e.g., scheduling beacons and groupcast SPs before QoS flow-set SPs based on higher priority of the beacons and groupcast), such as determined as part of the SLAs. Once the SPs are sequenced by priority, the SPs can be scheduled based on the TSTTs and PTs. While scheduling the SPs is based on the TSTTs, the SPs can be delayed as necessary for higher priority traffic or to accommodate SPs with lower PT. In example implementations, a SP can optionally be scheduled ahead of higher priority traffic if the PT of the SP cannot be met when scheduling by priority. Scheduling the SPs will be described in further detail herein with respect to FIGS. 3-7.

FIG. 3 is a block diagram of a SP schedule 300. The SP schedule 300 includes first AP beacons and groupcast 302, second AP beacons and groupcast 304, third AP beacons and groupcast 306, a first QoS flow 308, a second QoS flow 310, a third QoS flow 312, a fourth QoS flow 314, a fifth QoS flow 316, and a sixth QoS flow 318. The first AP, the second AP, and the third AP may be neighboring co-channel APs 102, such as AP1 102, AP2 102, and AP3 102. The first QoS flow 308 and the second QoS flow 310 may be associated with the first AP BSS, the third QoS flow 312 and the fourth QoS flow 314 may be associated with the second AP BSS, and the fifth QoS flow 316 and the sixth QoS flow 318 may be associated with the third AP BSS. Therefore, the first QoS flow 308 and the second QoS flow 310 can be included in the same flow-set, the third QoS flow 312 and the fourth QoS flow 314 can be included in the same flow-set, and the fifth QoS flow 316 and the sixth QoS flow 318 can be included in the same flow-set.

The SP schedule 300 begins with scheduling a first AP beacon burst and groupcast flow 320, a second AP beacon burst and groupcast flow 322, and a third AP beacon burst and groupcast flow 324 because the beacon and groupcast flows have higher priority than the QoS flows in the example implementation. The first AP beacon burst and groupcast flow 320, the second AP beacon burst and groupcast flow 322, and the third AP beacon burst and groupcast flow 324 are shown positioned according to the TSTT (e.g., TBTT) of the respective flow, illustrating the ideal time for transmission if the channel was not busy. The beacon and groupcast flows can be scheduled according to their TSTT and delayed to accommodate the SPs of other flows. Thus, the first AP beacon burst and groupcast flow 320 has the earliest TSTT or otherwise requests to be scheduled for transmission first, and a first AP beacon burst and groupcast flow SP 326 is scheduled immediately or nearly immediately. The second AP beacon burst and groupcast flow 322 follows the first AP beacon burst and groupcast flow 320, so a second AP beacon burst and groupcast flow SP 328 is scheduled after the first AP beacon burst and groupcast flow SP 326. The third AP beacon burst and groupcast flow 324 is last (e.g., latest TSTT), so the third AP beacon burst and groupcast flow SP 329 is scheduled after the second AP beacon burst and groupcast flow SP 328.

The first QoS flow 308 has first QoS traffic 330, the second QoS flow 310 has second QoS traffic 332, the third QoS flow 312 has third QoS traffic 334, the fourth QoS flow 314 has fourth QoS traffic 336, the fifth QoS flow 316 has fifth QoS traffic 338, and the sixth QoS flow 318 has sixth QoS traffic 340 for scheduling during the transmission of the beacon and group cast traffic. The first QoS traffic 330, the second QoS traffic 332, the third QoS traffic 334, the fourth QoS traffic 336, the fifth QoS traffic 338, and the sixth QoS traffic 340 are shown according to the TSTT of the respective flow, illustrating the ideal transmission time if the channel was not busy. All QoS traffic is delayed until after the third AP beacon burst and groupcast flow SP 329 since the QoS traffic has lower priority in the example implementation.

The second QoS traffic 332 may have the soonest starting time for its TSTT, so the first QoS flow 308 and the second QoS flow 310 are scheduled the first QoS flow-set SP 350 after the third AP beacon burst and groupcast flow SP 329. The fifth QoS traffic 338 may have the second soonest starting time for its TSTT, so the fifth QoS flow 316 and the sixth QoS flow 318 are scheduled at the second QoS flow-set SP 352 after the first QoS flow-set SP 350. As shown in FIG. 3, additional fifth QoS traffic 338 and sixth QoS flow 318 can be transmitted during the second QoS flow-set SP 350 if there is time to transmit the additional traffic. The third QoS flow 312 and the fourth QoS flow 314 can be scheduled the third QoS flow-set SP 354 after the second QoS flow-set SP 352. Traffic with a TSTT during a SP can be transmitted during the SP if there is time, so the additional fourth QoS traffic 336 can be transmitted during the third QoS flow-set SP 354.

The first QoS flow 308 and the second QoS flow 310 then have QoS traffic with TSTTs during the third QoS flow-set SP 354, so the fourth QoS flow-set SP 356 is scheduled for the first QoS traffic 330 and the second QoS traffic 332 after the third QoS flow-set SP 354. Flows can have periodic traffic with no other flows having the same or similar SI and/or SST. Thus, the third QoS traffic 334 can be scheduled a first flow SP 358 after the fourth QoS flow-set SP 356 for example. When the channel is not busy, the flow-set SP can immediately be scheduled at the start of the TSTT of a flow, so the fifth QoS flow-set SP 360 can be scheduled at the ideal time for the fifth QoS traffic 338 and include the sixth QoS traffic 340. Similarly, a SP for a single flow can be immediately scheduled when the channel is not busy, so the second flow SP 362 can be scheduled at the ideal time for the third QoS traffic 334. The seventh QoS flow-set SP 364, the third flow SP 366, and the eighth QoS flow-set SP 368 can be similarly scheduled according to the TSTTs.

Flow-sets can be grouped and ungrouped as the periodic flows drift closer and further apart. Flow-set SPs and flow SPs can therefore be adjusted as the flow-sets change. Additionally, the traffic of a SP can be attempted at any time, from the TSTT of the traffic until its expiry, unlike R-TWT.

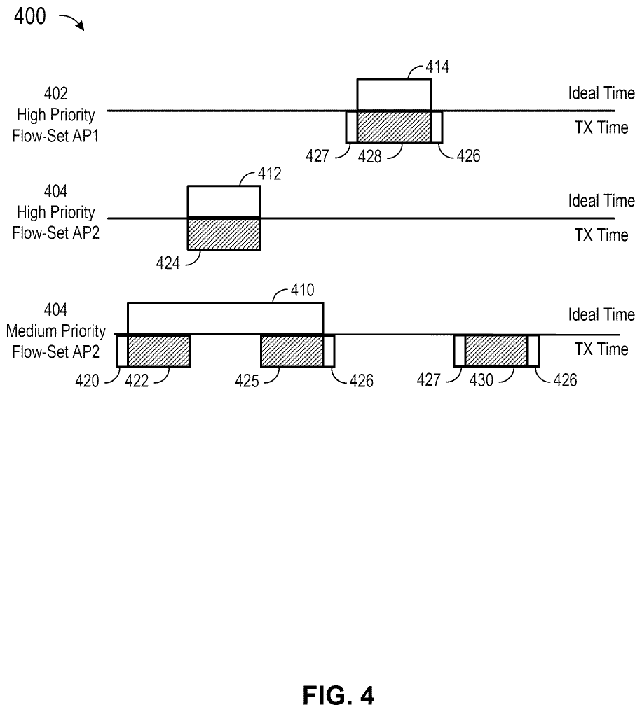

FIG. 4 is a block diagram of a SP schedule with pause and resume operations 400. The SP schedule with pause and resume operations 400 includes a high priority flow-set of AP1 402, a high priority flow-set of AP2 404, and a medium priority flow-set of AP2 406. All APs seek to achieve the SLAs and schedule SPs in priority order using distributed logic in example implementations. A TXOP-holding AP can use coordination techniques (e.g., C-TDMA) to offer medium time to a neighboring co-channel AP to meet that AP's expected (e.g., current or overdue) SPs whenever the underlying PTSIs are agreed and have higher priority than the AP's own SPs. This can involve pausing and resuming a SP having a minimum length if a higher priority SP begins in the middle.

AP2 102 has AP2 medium priority traffic 410 and AP2 high priority traffic 412, and AP1 102 has AP1 high priority traffic 414. The medium AP2 medium priority traffic 410, AP2 high priority traffic 412, and AP1 high priority traffic 414 is shown at the TSTT of the respective traffic. Thus, the AP2 medium priority traffic 410 is the earliest, and an initial Control Frame (CF) 420 and a first SP 422 during the period no high priority is to be scheduled. The AP2 high priority traffic 412 can be scheduled at its ideal time for the second SP 424, and AP2 102 can pause the transmission of medium priority traffic and transmit high priority traffic during the second SP 424. The AP2 medium priority traffic 410 can then resume transmission during the third SP 425.

The transmission of AP2 medium priority traffic 410 can again pause for the AP1 high priority traffic 414. Because the traffic is associated with a separate AP 102, AP2 102 can transmit a handover CF 426 to indicate to AP1 102 that it can use the channel. AP1 102 can transmit a handover reception CF 427 to indicate a successful handover and use of the channel, transmit the AP1 high priority traffic 414 at its ideal time via the fourth SP 428, and transmit a handover CF 426 to indicate to AP2 102 that it can resume use of the channel. AP2 102 can finish sending the AP2 medium priority traffic 410 by transmitting a handover reception CF 427, transmitting the remaining AP2 medium priority traffic 410 via fifth SP 430, and transmitting a handover CF 426. The handover CF 426 is only transmitted if there is a SP immediately following the fifth SP 430 in example implementations. Neighboring co-channel APs 102 can therefore pause and resume transmitting traffic to enable using the channel when higher priority traffic is not scheduled for transmission while avoiding delaying transmission of higher priority traffic when it is scheduled.

Pausing and resuming SPs can be unsuccessful in some examples. For instance, the device with the highest priority SP may be one hop away and given access to the medium but still be busy due to activity in a two hop BSS. Later C-TDMA polling may therefore be implemented to ensure the pausing and resuming of SPs will be leveraged for transmitting higher priority traffic.

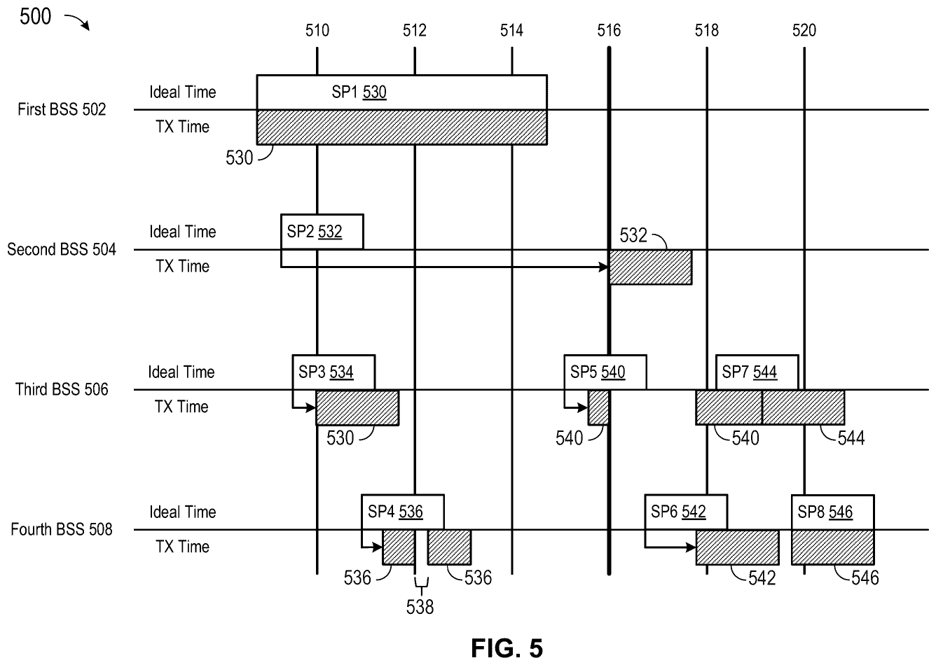

FIG. 5 is a block diagram of a SP schedule with queue jumping 500. The SP schedule with queue jumping 500 includes a first BSS 502, a second BSS 504, a third BSS 506, and a fourth BSS 508. Each BSS includes an AP 102 and one or more STAs 104. In the illustrated embodiment, the first BSS 502, the third BSS 506, and the fourth BSS 508 each are only neighbor co-channel APs with the second BSS 504, so the first BSS 502, the third BSS 506, and the fourth BSS 508 can transmit simultaneously without interfering with one another. However, the second BSS 504 must consider the transmissions of each neighbor to avoid interference. The APs 102 of the BSSs can implement queue jumping to avoiding having to unnecessarily wait for a neighbor co-channel AP 102 to be able to transmit, such as waiting for a SP of the second BSS 504.

When implementing queue jumping, the APs 102 can utilize transmit boundaries to initiate transmission, pause transmission, check for transmissions of higher priority traffic, and/or the like. For example, a SP that has been queue jumped can be scheduled for the next transmit boundary that the channel will be open after the higher priority SP concludes. The SP schedule with queue jumping 500 comprises a first transmit boundary 510, a second transmit boundary 512, a third transmit boundary 514, a fourth transmit boundary 516, a fifth transmit boundary 518, and a sixth transmit boundary 520.

The first BSS 502 has a first SP 530 that is scheduled for transmission at its ideal time since it has the earliest TSTT. The second BSS 504 has a second SP 532 with next earliest TSTT or otherwise the highest priority according to SP, so the second SP 532 would be next scheduled SP after the first SP 530. The second SP 532 would thus delay the third BSS 506 and the fourth BSS from transmitting until the second SP 532 completes without queue jumping. To perform queue jumping, the AP 102 of the third BSS 506 can determine that a third SP 534 has the next highest priority after the second SP 532 and determine that the second SP 532 is not scheduled for a period for a reason unknown or otherwise irrelevant to the third BSS 506 since it is not neighbors with the first BSS 502. The third BSS 506 waits until the first transmit boundary 510 to verify the second BSS 504 is not going to transmit. Once the third BSS 506 determines the second BSS 504 is not going to transmit, the third BSS 506 schedules the third SP 534 to start at the first transmit boundary 510.

Similarly, the AP 102 of the fourth BSS 508 determines the fourth SP 536 has the next highest priority after the second SP 532 (e.g., because the third SP 534 is not an SP of a neighbor), determines the second SP 532 is not scheduled for a period for a reason unknown or otherwise irrelevant to the fourth BSS, waits for a period to verify the second BSS 504 is not going to transmit, and starts transmitting during the scheduled fourth SP 536. At the second transmit boundary, the fourth BSS 508 pauses the fourth SP 536 for a delay period 538 to determine whether the second BSS 504 is starting the second SP 532. The fourth BSS 508 pauses because it may not be aware of the length of the first SP 530 and must allow the higher priority second SP 532 to begin if the first SP 530 has concluded. Once the fourth BSS 508 determines the second SP 532 was not started, the fourth BSS 508 resumes the fourth SP 536.

The fifth SP 540 illustrates pausing at the fourth transmit boundary 516, the third BSS 506 recognizing that the second SP 532 occurs at the fourth transmit boundary 516, and the third BSS 506 resuming the fifth SP 540 after the second SP532. When there is no SP that a BSS is queue jumping, the SP do not need to be delayed or paused at the transmit boundaries to verify whether the SP being queue jumped is occurring. Thus, the sixth SP 542, the seventh SP 544, and the eighth SP 546 can be scheduled and transmitted normally without delays or pauses at the transmit boundaries since there is no SP being queue jumped.

Collision queue rules can be implemented to prevent SP collisions when multiple neighboring co-channel APs determine to queue jump (e.g., AP1 102 and AP2 102 determine to queue jump a SP associated with AP3 102. In certain embodiments, the collision queue rules follow AP-to-AP deterministic linear backoff based on upcoming SPs, and the SPs can be ordered by PT (e.g., one slot delay per position in the list of upcoming SPs). Thus, the queue jumping is scheduled like the SPs are scheduled, with higher priority SPs (e.g., earlier TSTT and/or lower PT) queue jumping sooner than lower priority SPs. In other embodiments, the collision queue rules follow AP-to-AP random linear backoff. For example, the nth SP in the list of upcoming SPs backs off a random amount of the total number of slots available for queue jumping (e.g., (n*M) to (n+1)*M−1 slots, where there are M total slots).

Furthermore, queue jumping SPs can have constrained extents defining when all queue jumping SPs must end for a particular period. For example, queue-jumping must end after a set amount of transmit boundaries occur since the TSTT of the SP that is being queue jumped (e.g., Time Synchronization Function (TSF)=nΔ, where A is transmit boundary). Using the TSF of the queue jumped AP and transmit boundaries typically equals one to TUs or similar (one to two milliseconds, etc.). The constrained extents can ensure the queue jumped SP can eventually occur, such as if APs 102 are not monitoring for the start of the queue-jumped SP and/or pausing at transmit boundaries. In example implementations, the constrained extents are a R-TWT agreement.

In certain embodiments, the queue jumping can be optimized if there is more than one queue jumped SP and/or AP 102 at a time by dividing the durations of the queue jumping SPs. For example, neighbor APs may attempt to synchronize their TSFs modulo Δ (e.g., via Precision Time Protocol (PTP), Generalized PTP (gPTP) with gentle digital TSF adjustments, etc.). This optimization may be available if the respective APs 102 are in the same administrative domain. When the normal time for the queue jumped SP occurs, the associated AP 102 can send a minimal-length SP.

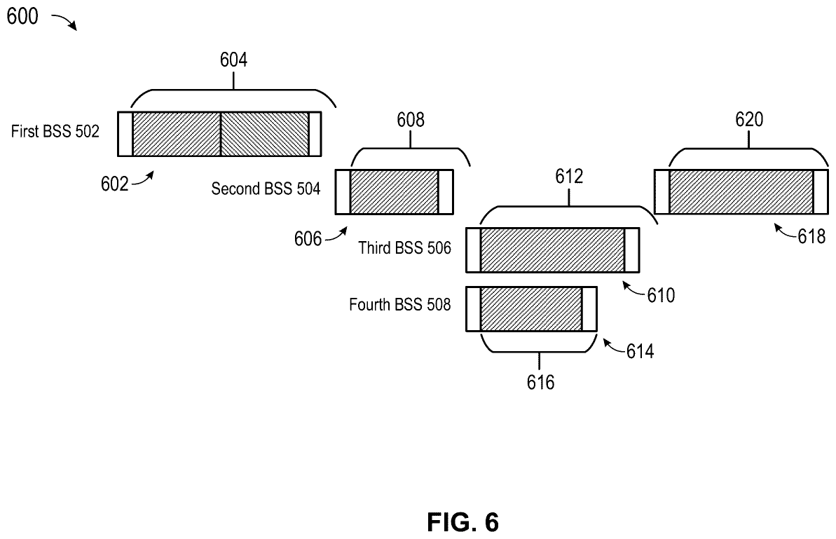

FIG. 6 is a block diagram of a SP schedule with SP chaining 600. The SP schedule with SP chaining 600 includes the first BSS 502, the second BSS 504, the third BSS 506, and the fourth BSS 508. The first BSS 502, the third BSS 506, and the fourth BSS 508 each are only neighbor co-channel APs with the second BSS 504 for the illustrated embodiment.

The APs 102 can perform SP chaining to enable transmission of back-to-back SPs until the finished or a TXOP limit is reached. As illustrated, the APs 102 can perform SP chaining by setting the Network Allocation Vector (NAV) for the length of the planned SP plus an extra period for the next SP to start transmitting. Thus, the first BSS transmission 602 is transmitted, and the first BSS NAV 604 is set to end an extra period after the end of the first BSS transmission 602. The first BSS transmission 602 can include an initial CF 420, one or more SPs, and/or a handover CF 426. The second BSS transmission 606, the third BSS transmission 610, the fourth BSS transmission 614, and the fifth BSS transmission 618 can include the handover reception CF 427, one or more SPs and the handover CF 426. The initial CF 420, the handover CF 426, and the handover reception CF 427 can be present during SP chaining to assign the medium to the next AP in the chain and accept the medium as the next AP in the chain.

During the extra period of the first BSS NAV 604, the second BSS 504 is assigned the medium, such as via C-TDMA. The second BSS transmission 606 is then transmitted, and the second BSS NAV 608 is the length of the second BSS transmission 606 plus an extra period. During the extra period of the second BSS NAV 608, the third BSS 506 and the fourth BSS 508 are both assigned the medium, such as via multi-AP C-TMDA. Both BSSs can be assigned the medium since the third BSS 506 and the fourth BSS 508 are not neighbors. Allowing for multiple handover target APs 102 allows for spatial reuse.

The third BSS transmission 610 can be transmitted with the third BSS NAV 612 set to the length of the third BSS transmission 610 plus an extra period, and the fourth BSS transmission 614 can be transmitted with the fourth BSS NAV 616 set to the length of the fourth BSS transmission 614 plus an extra period. The medium is not assigned to the second BSS 504 during the extra period of the fourth BSS transmission 614 because the third BSS 506 is still transmitting and is a neighbor of the second BSS 504. Thus, the medium can be assigned back to the second BSS 504 during the extra period of the third BSS NAV 612. The additional second BSS transmission 618 can be transmitted and the additional second BSS NAV 620 can be the length of the additional second BSS transmission 618 when the SPs are finished and/or the TXOP limit is reached.

Once the TXOP limit is reached and the SP chaining stops, SP scheduling according to priority as described above resumes. As described above, the first BSS transmission 602, the second BSS transmission 606, the third BSS transmission 610, the fourth BSS transmission 614, and the additional second BSS transmission 618 can include the handover reception CF 427 and the handover CF 426 for reporting SP progress, handing over the medium to the next AP(s) 102 in the chain, and accepting the medium as next AP 102. In example implementations, the initial CF 420 and the handover reception CF 427 each comprise Multi-User-Request to Send (MU-RTS) Trigger TXOP Sharing (TXS) and Clear to Send (CTS) process. The handover CF 426 is TXS or CF-End+TXS in example implementations. For coordination purposes, an AP 102, at the start of its SP (e.g., via the initial CF 420 or handover reception CF 427), can announce its current flow-set(s) and lists handover target AP(s) 102.

In certain embodiments, an AP 102 may act as the controlling AP for the AP chaining, and control must be handed back to the controlling AP before continuing the AP chaining. For example, the AP 102 of the first BSS 502 may act as the controlling AP, so the second BSS 504 would hand back control to the first BSS 502 after the second BSS transmission 606. The first BSS 502 can then assign the medium to the third BSS 506 and the fourth BSS 508, the third BSS 506 and the fourth BSS 508 can hand back control to the first BSS 502 after the third BSS transmission 610 and the fourth BSS transmission 614 respectively, and the first BSS 502 can assign the medium to the second BSS 504.

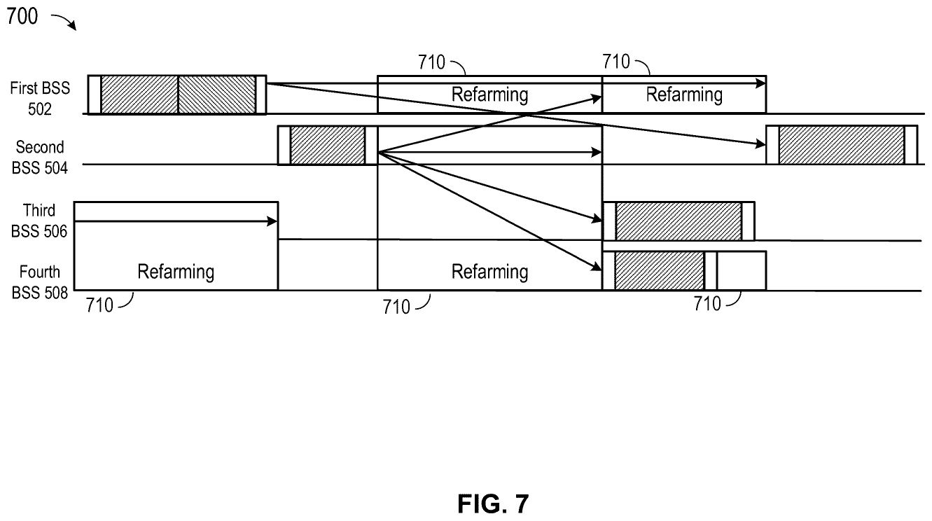

FIG. 7 is a block diagram of a SP schedule with refarming 700. The SP schedule with refarming 700 includes the first BSS 502, the second BSS 504, the third BSS 506, and the fourth BSS 508. The first BSS 502, the third BSS 506, and the fourth BSS 508 each are only neighbor co-channel APs with the second BSS 504 for the illustrated embodiment. A typical environment will have gaps, such as periods of CSMA/CA, between shorter periods of MAPC SP chains. The gaps should be refarmed for unpredictable (e.g., non-periodic) traffic, such as aperiodic high priority traffic, deferred retries of flow-sets, Best Effort (BE) traffic, Background (BK) traffic, probing, power management transitions, and so on. Additionally, at the next TSTT of a neighbor co-channel AP, transmissions should stop (e.g., carrier sense idle for the AP 102 of the associated SP) so the MAPC SP can begin with no delay caused by the refarming. Thus, the first BSS 502, the second BSS 504, the third BSS 506, and the fourth BSS 508 can perform gap refarming 710 without interfering with SPs.

A Start Time Protection Rule (STPR) is implemented to require TXOPs, such as TXOPs from gaps being refarmed, end before an upcoming SP of a neighboring co-channel AP 102. The STPR may be utilized from R-TWT, but no R-TWT agreement is required. There are multiple options for utilizing the STPR. Only the APs 102 support the first option, where each AP 102 contends and uses triggered access up to the next TSTT. Thus, STAs 104 will not interfere with an SP since the STAs can only respond at times controlled by the triggered access. UORA is also made ubiquitously available.

For the second option, APs 102 can manage the STPR for STAs 104 proactively. When an AP 102 is an initiator of a communication, the AP 102 respects the STPR. When an AP 102 is a responder in a TXOP that overlaps the next TSTT, the AP 102 aborts, truncates, or early terminates the TXOP (e.g., via IDC signaling).

For the third option, APs 102 can announce upcoming TSTTs as needing STPR for neighboring co-channel APs and the STAs 104 to be aware of the upcoming SP and to avoid interfering with the SP. The announcement can be sent via elements in beacons of leading TSTTs based on nominal SP duration, a new field in ICF, a handover CF 426, and/or the like.

The SP scheduling techniques described above with respect to FIGS. 3-7 can be utilized in any combination to efficiently schedule SPs. Thus, the APs 102 can schedule SPs via disseminating flows, establishing SLAs for flow-sets, sequencing SPs by priority, enabling queue jumping, protecting SPs via SP chaining and TXOP chaining, and/or refarming gaps between chained SPs.

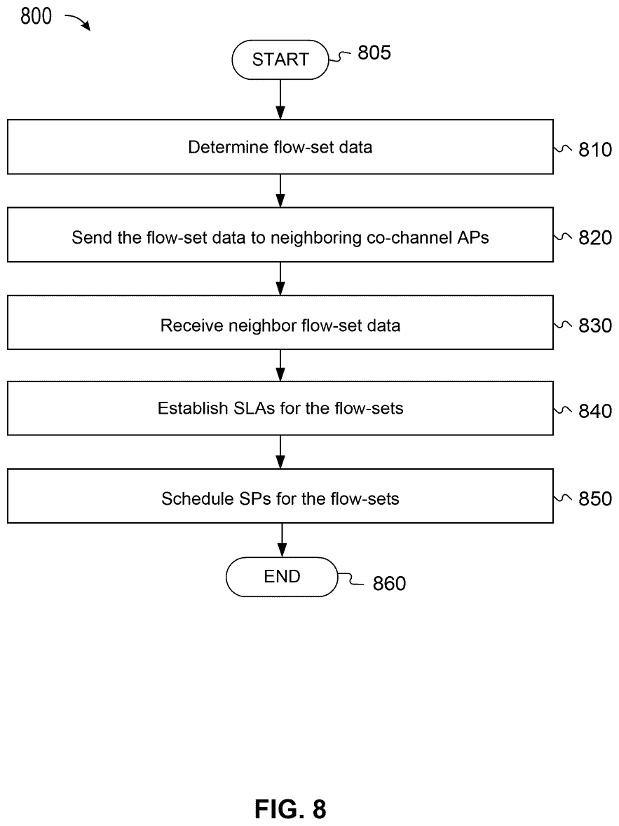

FIG. 8 is a flow chart of a method 800 for Multi-AP coordinated SPs. The method 800 may be described as performed by the APs 102, but other network devices such as controllers can perform one or more of the operations in further embodiments. The method 800 may begin at starting block 805 and proceed to operation 810. In operation 810, flow-set data is determined. For example, the APs 102 receive reports of QoS traffic flows from their STAs 104, via a SCS frame comprising a QC element. The APs 102 can also determine additional flows of the APs 102 (e.g., beacons and groupcast flows) and additional flows of the STAs 104. The APs 102 can determine flow-sets and data for the flow-sets (e.g., PTSIs, QC element data, etc.).

In operation 820, the flow-set data is sent to neighboring co-channel APs. For example, an AP 102 can send the flow-set data directly or indirectly to the neighboring co-channel APs. In operation 830, neighbor flow-set data is received. For example, an AP 102 directly or indirectly receives flow-set data of the neighbor AP flow-sets.

In operation 840, SLAs are established for the flow-sets and the neighbor AP flow-sets. For example, using the exchanged flow-set data and neighbor flow-set data, the neighboring co-channel APs 102 determine SLAs for every flow-set to meet the requirements and parameters of the respective flow-set.

In operation 850, SPs are scheduled for the flow-sets. For example, SPs are scheduled according to the method described above, including sequencing SPs by priority, enabling queue jumping, protecting SPs via SP chaining and TXOP chaining, and/or refarming gaps between chained SPs. Scheduling the SPs can comprise, for each SP, determining a TSTT and PT and scheduling the SP based on the TSTT and PT.

In certain embodiments, the method 800 comprises queue jumping a higher priority SP by determining the higher priority SP is not initiated and scheduling a new SP before the higher priority SP. The method 800 includes pausing the new SP at a transmit boundary in example implementations. When the higher priority SP initiates at the transmit boundary, the new SP is resumed after the higher priority SP. When the higher priority SP does not initiate for a delay period 538, the new SP is resumed after the delay period 538.

The method 800 can comprise pausing an in-progress SP for a higher priority SP and resuming the in-progress SP after the higher priority SP. The method 800 can further include performing SP chaining for a plurality of sequential SPs. Additionally, the method 800 can comprise refarming a gap between SPs for aperiodic high priority traffic, deferred retries of flow-sets, BE traffic, BK traffic, probing, a power management transition, and/or the like. The method 800 may conclude at ending block 860.

FIG. 9 is a block diagram of a computing device 900. As shown in FIG. 9, computing device 900 may include a processing unit 910 and a memory unit 915. Memory unit 915 may include a software module 920 and a database 925. While executing on processing unit 910, software module 920 may perform, for example, processes for MAPC SPs and techniques with respect to FIGS. 1-7. Computing device 900, for example, may provide an operating environment for the APs 102, the STAs 104, the peripheral device 201, and the like. The APs 102, the STAs 104, the peripheral device 201, and the like may operate in other environments and are not limited to computing device 900.

Computing device 900 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 900 may comprise any computer operating environment, such as hand-held devices, multiprocessor systems, microprocessor-based or programmable sender electronic devices, minicomputers, mainframe computers, and the like. Computing device 900 may also be practiced in distributed computing environments where tasks are performed by remote processing devices. The aforementioned systems and devices are examples, and computing device 900 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device. In an example, there is provided a computer readable medium carrying instructions which, when executed by one or more processors, cause any of the methods described herein to be carried out.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a SOC where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 900 on the single integrated circuit (chip).

FIG. 10 illustrates an implementation of a communications device 1000 that may implement one or more of the APs 102, the STAs 104, the peripheral device 201, etc., of FIGS. 1-7. In various implementations, the communications device 1000 may comprise a logic circuit. The logic circuit may include physical circuits to perform operations described for one or more of the APs 102, the STAs 104, the peripheral device 201, etc., of FIGS. 1-7, for example. As shown in FIG. 10, the communications device 1000 may include one or more of, but is not limited to, a radio interface 1010, baseband circuitry 1030, and/or the computing device 900.

The communications device 1000 may implement some or all of the structures and/or operations for the APs 102, the STAs 104, the peripheral device 201, etc., of FIGS. 1-7, storage medium, and logic circuit in a single computing entity, such as entirely within a single device. Alternatively, the communications device 1000 may distribute portions of the structure and/or operations using a distributed system architecture, such as a client station server architecture, a peer-to-peer architecture, a master-slave architecture, etc.

A radio interface 1010, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface omodulation scheme. The radio interface 1010 may include, for example, a receiver 1015 and/or a transmitter 1020. The radio interface 1010 may include bias controls, a crystal oscillator, and/or one or more antennas 1025. In additional or alternative configurations, the radio interface 1010 may use oscillators and/or one or more filters, as desired.

The baseband circuitry 1030 may communicate with the radio interface 1010 to process, receive, and/or transmit signals and may include, for example, an Analog-To-Digital Converter (ADC) for down converting received signals with a Digital-To-Analog Converter (DAC) 1035 for up converting signals for transmission. Further, the baseband circuitry 1030 may include a baseband or PHY layer processing circuit for the PHY link layer processing of respective receive/transmit signals. Baseband circuitry 1030 may include, for example, a MAC processing circuit 1040 for MAC/data link layer processing. Baseband circuitry 1030 may include a memory controller for communicating with MAC processing circuit 1040 and/or a computing device 900, for example, via one or more interfaces 1045.

In some configurations, PHY processing circuit may include a frame construction and/or detection module, in combination with additional circuitry such as a buffer memory, to construct and/or deconstruct communication frames. Alternatively or in addition, MAC processing circuit 1040 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
determining flow-set data comprising data for one or more Quality of Service (QOS) flows-sets of one or more clients;
sending the flow-set data to one or more neighboring co-channel Access Points (APs);
receiving neighbor flow-set data comprising data for one or more neighbor QoS flow-sets from at least one of the one or more neighboring co-channel APs;
establishing Service Level Agreements (SLAs) for the one or more QoS flow-sets and the one or more neighbor QoS flow-sets based on the flow-set data and the neighbor flow-set data; and
scheduling one or more Service Periods (SPs) for at least one of the one or more QoS flow-sets and the one or more neighbor QoS flow-sets based on the SLAs.

2. The method of claim 1, wherein scheduling the one or more SPs comprises, for each SP:
determining a Target SP Transmission Time (TSTT);
determining a Priority Time (PT); and
scheduling the SP based on the TSTT and the PT.

3. The method of claim 1, further comprising queue jumping a higher priority SP by determining the higher priority SP is not initiated and scheduling a new SP before the higher priority SP.

4. The method of claim 3, further comprising:
pausing the new SP at a transmit boundary;
when the higher priority SP initiates at the transmit boundary, resuming the new SP after the higher priority SP; and
when the higher priority SP does not initiate for a delay period, resuming the new SP after the delay period.

5. The method of claim 1, further comprising:
pausing an in-progress SP for a higher priority SP; and
resuming the in-progress SP after the higher priority SP.

6. The method of claim 1, further comprising performing SP chaining for a plurality of sequential SPs.

7. The method of claim 1, further comprising refarming a gap between SPs for any one of (i) aperiodic high priority traffic, (ii) deferred retries of flow-sets, (iii) Best Effort (BE) traffic, (iv) Background (BK) traffic, (v) probing, (vi) a power management transition, or (vii) any combination of (i)-(vi).

8. A system comprising:
a memory storage; and
a processing unit coupled to the memory storage, wherein the processing unit is operative to:
determine flow-set data comprising data for one or more Quality of Service (QOS) flows-sets of one or more clients;
send the flow-set data to one or more neighboring co-channel Access Points (APs);
receive neighbor flow-set data comprising data for one or more neighbor QoS flow-sets from at least one of the one or more neighboring co-channel APs;
establish Service Level Agreements (SLAs) for the one or more QoS flow-sets and the one or more neighbor QoS flow-sets based on the flow-set data and the neighbor flow-set data; and
schedule one or more Service Periods (SPs) for at least one of the one or more QoS flow-sets and the one or more neighbor QoS flow-sets based on the SLAs.

9. The system of claim 8, wherein to schedule the one or more SPs comprises to, for each SP:
determine a Target SP Transmission Time (TSTT);
determine a Priority Time (PT); and
schedule the SP based on the TSTT and the PT.

10. The system of claim 8, the processing unit being further operative to queue jump a higher priority SP by determining the higher priority SP is not initiated and scheduling a new SP before the higher priority SP.

11. The system of claim 10, the processing unit being further operative to:
pause the new SP at a transmit boundary;
when the higher priority SP initiates at the transmit boundary, resume the new SP after the higher priority SP; and
when the higher priority SP does not initiate for a delay period, resume the new SP after the delay period.

12. The system of claim 8, the processing unit being further operative to:
pause an in-progress SP for a higher priority SP; and
resume the in-progress SP after the higher priority SP.

13. The system of claim 8, the processing unit being further operative to perform SP chaining for a plurality of sequential SPs.

14. The system of claim 8, the processing unit being further operative to refarm a gap between SPs for any one of (i) aperiodic high priority traffic, (ii) deferred retries of flow-sets, (iii) Best Effort (BE) traffic, (iv) Background (BK) traffic, (v) probing, (vi) a power management transition, or (vii) any combination of (i)-(vi).

15. A non-transitory computer-readable medium that stores a set of instructions which when executed perform a method executed by the set of instructions comprising:
determining flow-set data comprising data for one or more Quality of Service (QOS) flows-sets of one or more clients;
sending the flow-set data to one or more neighboring co-channel Access Points (APs);
receiving neighbor flow-set data comprising data for one or more neighbor QoS flow-sets from at least one of the one or more neighboring co-channel APs;
establishing Service Level Agreements (SLAs) for the one or more QoS flow-sets and the one or more neighbor QoS flow-sets based on the flow-set data and the neighbor flow-set data; and
scheduling one or more Service Periods (SPs) for at least one of the one or more QoS flow-sets and the one or more neighbor QoS flow-sets based on the SLAs.

16. The non-transitory computer-readable medium of claim 15, wherein scheduling the one or more SPs comprises, for each SP:
determining a Target SP Transmission Time (TSTT);
determining a Priority Time (PT); and
scheduling the SP based on the TSTT and the PT.

17. The non-transitory computer-readable medium of claim 15, the method executed by the set of instructions further comprising queue jumping a higher priority SP by determining the higher priority SP is not initiated and scheduling a new SP before the higher priority SP.

18. The non-transitory computer-readable medium of claim 17, the method executed by the set of instructions further comprising:
pausing the new SP at a transmit boundary;
when the higher priority SP initiates at the transmit boundary, resuming the new SP after the higher priority SP; and
when the higher priority SP does not initiate for a delay period, resuming the new SP after the delay period.

19. The non-transitory computer-readable medium of claim 15, the method executed by the set of instructions further comprising:
pausing an in-progress SP for a higher priority SP; and
resuming the in-progress SP after the higher priority SP.

20. The non-transitory computer-readable medium of claim 15, the method executed by the set of instructions further comprising performing SP chaining for a plurality of sequential SPs.
